(19) United States
(12) Patent Application Publication
(10) Pub. No.: US 2005/0202207 A1
(43) Pub. Date: Sep. 15, 2005

(54) Method of manufacturing ceramic honeycomb structure

(75) Inventor: Takashi Inaba, Nagoya-city (JP)

Correspondence Address: STEPTOE & JOHNSON LLP, 1330 CONNECTICUT AVENUE, N.W., WASHINGTON, DC, 20036, US

(73) Assignee: NGK Insulators, Ltd., Nagoya-city (JP)

(21) Appl. No.: 11/067,703

(22) Filed: Mar. 1, 2005

(30) Foreign Application Priority Data
Mar. 15, 2004 (JP) 2004-073041

(51) Int. Cl. B65D 1/00; B32B 3/12

(52) U.S. Cl. 428/116; 428/34.4; 264/630

(57) ABSTRACT

A method of manufacturing a ceramic honeycomb structure, includes: an extruding step of extruding a raw material including a ceramic material, and obtaining a ceramic honeycomb intermediate formed article which has substantially the same shape as that of the ceramic honeycomb structure to obtain and whose outer peripheral wall has a thickness of 1/15 to 1/120 with respect to an outer diameter of ceramic honeycomb intermediate formed article; a firing step of firing the obtained ceramic honeycomb intermediate formed article to obtain a ceramic honeycomb fired article; and a machining step of machining the outer peripheral wall of the obtained ceramic honeycomb fired article, and securing a dimensional precision of a predetermined outer diameter. According to the method of manufacturing a ceramic honeycomb structure, a partition wall inside an outer peripheral wall, or the outer peripheral wall itself does not easily deform at an extruding time, and the inside partition walls and through-holes are not exposed at the time of machining of the outer peripheral wall, and any coating layer does not have to be disposed.

### BACKGROUND OF THE INVENTION

1. Field of the Invention

The present invention relates to a method of manufacturing a ceramic honeycomb structure.

2. Description of the Related Art

In recent years, ceramic honeycomb structure having through-holes partitioned by porous partition walls have been used as filters for gas-liquid separation, solid-liquid separation, and gas-solid separation. The ceramic honeycomb structure generally comprises a cylindrical article, and has an outer peripheral wall, a partition wall disposed inside the outer peripheral wall, and a plurality of through-holes partitioned by the partition walls and formed in an axial direction of the cylindrical article. The filter using the ceramic honeycomb structure is superior in physical strength, durability, resistance to corrosion and the like as compared with an organic polymer membrane or the like for use in similar application, and has therefore preferably been used in removing suspension materials, bacterial, powder dust and the like in liquid or gas in broad fields such as water treatment, exhaust gas treatment, medical industry and food industry.

The ceramic honeycomb structure has been usually prepared through extruding, drying, and firing steps, and an unavoidable dimensional error, and deformation are sometimes generated in the respective steps. First, since the obtained formed article contains water, binder and the like in the extruding step, the article is very soft, and is sometimes easily deformed because of its own weight. Especially, in a larger type, for example, when a material is extruded in a vertical direction by gravity, the through-holes on an outer peripheral wall side easily break because of own weights. When the material is extruded in a direction parallel to the gravity, a lower part of the obtained formed article easily buckles by the own weight. Furthermore, in the drying and firing steps, it is difficult to completely uniform dry and/or fire the article, and therefore a fluctuation of a contraction (shrinkage) ratio could be generated depending on each portion of a product. Therefore, a completed product has a slightly inferior precision of the outer diameter, or a defect that a cylindrical shape has a slightly unsatisfactory cylindricality or sectional circularity.

To solve the problem, means for thickening and forming the outer peripheral wall, and machining the outer peripheral wall after the firing to thereby enhance precision of an outer diameter has heretofore been taken. However, when the outer peripheral wall is thickened in extruding the material, there has been a problem that a partition wall inside the outer peripheral wall, or the outer peripheral wall itself is easily deformed. On the other hand, when the thickness of the outer peripheral wall is insufficient, there has been a problem that the partition wall inside the outer peripheral wall, and through-holes are exposed by the machining of the outer peripheral wall. On the other hand, in Japanese Utility Model Publication No. 7-183, a ceramic honeycomb structure has been proposed in which a coating layer is disposed on the outer peripheral wall, but much time and labor are required for forming and machining the coating layer. When the ceramic honeycomb structure is enlarged, the time and labor increase, and therefore there has been a demand for improvement.

### SUMMARY OF THE INVENTION

The present invention has been developed in view of the above-described situations, and an object thereof is to provide a method of manufacturing a new ceramic honeycomb structure, in which a partition wall inside an outer peripheral wall, or the outer peripheral wall itself is not easily deformed at an extruding time, or the inside partition wall and through-holes are prevented from being exposed at a machining time of the outer peripheral wall, and further any coating layer does not have to be disposed. As a result of repeated studies, it has been found that in means for determining the thickness of the outer peripheral wall beforehand in view of a change of an outer diameter by drying or firing in manufacturing the structure, and machining the outer peripheral wall after the firing to thereby enhance precision of the outer diameter, the thickness of the outer peripheral wall is set to a certain ratio with respect to the outer diameter, and accordingly the object can be achieved concretely by the following means.

That is, according to the present invention, there is provided a method (referred to also as a first manufacturing method) of manufacturing a ceramic honeycomb structure comprising a cylindrical article, and having: an outer peripheral wall; a partition wall disposed inside the outer peripheral wall; and a plurality of through-holes partitioned by the partition walls and formed in an axial direction of the cylindrical article, the method comprising: an extruding step; a firing step; and a machining step. In the extruding step, a ceramic honeycomb intermediate formed article is obtained having a thickness of the outer peripheral wall estimating a change of an outer diameter in the firing step. In the firing step, the ceramic honeycomb intermediate formed article is fired to obtain a ceramic honeycomb fired article. In the machining step, the outer peripheral wall of the ceramic honeycomb fired article is machined, and a dimensional precision of a predetermined outer diameter is secured.

Moreover, according to the present invention, there is provided a method (referred to also as a second manufacturing method) of manufacturing a ceramic honeycomb structure comprising a cylindrical article, and having: an outer peripheral wall; a partition wall disposed inside the outer peripheral wall; and a plurality of through-holes partitioned by the partition walls and formed in an axial direction of the cylindrical article, the method comprising: an extruding step of extruding a raw material including a ceramic material, and obtaining a ceramic honeycomb intermediate formed article which has substantially the same shape as that of the ceramic honeycomb structure to obtain and whose outer peripheral wall has a thickness of 1/15 to 1/120 with respect to an outer diameter of the ceramic honeycomb intermediate formed article; a firing step of firing the obtained ceramic honeycomb intermediate formed article to obtain a ceramic honeycomb fired article; and a machining step of machining the outer peripheral wall of the obtained ceramic honeycomb fired article, and securing a dimensional precision of a predetermined outer diameter.

In the second manufacturing method of the ceramic honeycomb structure according to the present invention, the thickness of the outer peripheral wall of the ceramic honeycomb intermediate formed article is preferably 2 to 20 times that of the partition wall.

The first and second methods of manufacturing the ceramic honeycomb structure according to the present invention (when referring to both the first and second manufacturing methods, the method of manufacturing the ceramic honeycomb structure according to the present invention will be simply referred to) are preferable in a case where the dimensional precision of the predetermined outer diameter is 1 mm or less as a deviation of a contour of a plane vertical to an axial line of the ceramic honeycomb structure. It is to be noted that the deviation of the contour of the plane vertical to the axial line indicates a magnitude of inaccuracy of the contour of the plane existing vertically to the axial line in the ceramic honeycomb structure comprising the cylindrical article. The magnitude is equal to cylindricality in a case where the ceramic honeycomb structure has a cylindrical shape.

Moreover, the manufacturing method is preferable in a case where the ceramic honeycomb structure is porous, and has a porosity of 20 to 60%.

Furthermore, the manufacturing method is preferable in a case where the ceramic honeycomb structure has an outer diameter of 50 mm or more.

The method of manufacturing the ceramic honeycomb structure according to the present invention is applicable to a case where a sectional shape of the ceramic honeycomb structure vertical to an axial direction of the cylindrical article is at least one selected from a group consisting of a circular shape, an elliptical shape, an oblong shape, a triangular shape, a quadrangular shape, a pentagonal shape, a hexagonal shape, and a heptagonal shape.

The method is also applicable to a case where a shape of the through-hole in a plane vertical to an axial direction of the cylindrical article of the ceramic honeycomb structure is at least one selected from a group consisting of a triangular shape, a quadrangular shape, a pentagonal shape, a hexagonal shape, a heptagonal shape, a circular shape, an elliptical shape, and an oblong shape.

Next, according to the present invention, there is provided a ceramic honeycomb intermediate formed article constituting a ceramic honeycomb structure which is fired later and whose outer peripheral wall is machined, the article comprising a cylindrical article, and having: an outer peripheral wall; a partition wall disposed inside the outer peripheral wall; and a plurality of through-holes partitioned by the partition walls and formed in an axial direction of the cylindrical article, the outer peripheral wall having a thickness of 1/15 to 1/120 with respect to an outer diameter of the article.

In the ceramic honeycomb intermediate formed article according to the present invention, the outer peripheral wall has a thickness of 2 to 20 times that of the partition wall.

In the first method of manufacturing the ceramic honeycomb structure according to the present invention, a ceramic honeycomb intermediate formed article is obtained having the thickness of the outer peripheral wall estimating the change of the outer diameter in the firing step, and the dimensional precision of the predetermined outer diameter of the ceramic honeycomb structure obtained by machining the outer peripheral wall after the firing is secured. Therefore, since the outer peripheral wall is not excessively thick, the partition wall inside the outer peripheral wall or the outer peripheral wall itself is inhibited from being deformed at the extruding time, and any through-hole does not collapse. Moreover, since the outer peripheral wall is not excessively thin, the partition walls and the through-holes are prevented from being exposed at the time of the machining of the outer peripheral wall.

Moreover, in the second method of manufacturing the ceramic honeycomb structure according to the present invention, the ceramic honeycomb intermediate formed article is prepared in which the thickness of the outer peripheral wall is defined in such a manner that a ratio of the thickness with respect to the outer diameter falls within a certain range. The article is fired and thereafter machined to thereby obtain the ceramic honeycomb structure. Therefore, since the outer peripheral wall is not excessively thick, the partition wall inside the outer peripheral wall or the outer peripheral wall itself is inhibited from being deformed at the extruding time, and any through-hole does not collapse. Moreover, since the outer peripheral wall is not excessively thin, the partition walls and the through-holes are prevented from being exposed at the time of the machining of the outer peripheral wall.

By the method of manufacturing the ceramic honeycomb structure according to the present invention, the ceramic honeycomb intermediate formed article is prepared, fired, and thereafter machined to obtain the ceramic honeycomb structure. Therefore, it is easier to prepare a ceramic honeycomb structure in which the deviation of the contour of the plane vertical to the axial line is 1 mm or less. In general, when the ceramic honeycomb structure is used as a filter, the structure is closely fitted in a predetermined case via a sealing material or a cushioning material in order to prevent leakage and enhance resistance to vibration. However, when the dimensional precision is bad, the thickness of the sealing material or the cushioning material needs to be changed, or a thick material needs to be used and adapted for a purpose of correcting a dimensional difference. However, in the ceramic honeycomb structure superior in dimensional precision, obtained by the method of manufacturing the ceramic honeycomb structure according to the present invention, a comparatively thin material having a constant thickness is usable, and constitutes an economically satisfactory filter. Since the fired article is machined, the surface of the outer peripheral wall becomes smooth, and any wavy concave/convex portion is not generated in an outer surface (surface of the outer peripheral wall) in an extruding direction as in the extruded article. Therefore, the filter is formed to be superior in sealing performance.

Moreover, in the porous ceramic honeycomb structure having a porosity of 20 to 60%, in general, there is a fear of deformation by the firing. However, in the method of manufacturing the ceramic honeycomb structure according to the present invention, it is easier to prepare a ceramic honeycomb structure in which the deviation of the contour of the plane vertical to the axial line is 1 mm or less.

Furthermore, when a coating layer is disposed, in a larger ceramic honeycomb structure, time and labor required for forming and machining the coating layer also increase. However, in the method of manufacturing the ceramic honeycomb structure according to the present invention, any coating layer does not have to be disposed, and there is not any time or labor required for forming or machining the layer. Even when the ceramic honeycomb structure is enlarged, the time or labor in the machining after the firing is substantially unchanged. Therefore, the method of manufacturing the ceramic honeycomb structure according to the present invention is more preferable means as compared with a conventional technique in a case where the ceramic honeycomb structure has an outer diameter of 50 mm or more.

### BRIEF DESCRIPTION OF THE DRAWINGS

FIG. 1(a) is a front view showing one example of a ceramic honeycomb structure which is an object of a method of manufacturing the ceramic honeycomb structure according to the present invention, and showing an end face of the structure;

FIG. 1(b) is a front view showing another example of the ceramic honeycomb structure which is an object of the method of manufacturing the ceramic honeycomb structure according to the present invention, and showing the end face of the structure; and

FIG. 2 is a perspective view showing one example of the ceramic honeycomb structure which is an object of the method of manufacturing the ceramic honeycomb structure according to the present invention.

### DESCRIPTION OF THE PREFERRED EMBODIMENT

Embodiments of the present invention will be hereinafter described appropriately with reference to the drawing, but the present invention is not limited to the embodiments in interpretation, and may be variously changed, modified, or improved based on knowledge of a person skilled in the art without departing from the scope of the present invention. For example, the drawings show the preferable embodiments of the present invention, and the present invention is not limited to a modification shown in the drawing, or information shown in the drawing. In carrying out or verifying the present invention, means similar or equivalent to those described in the present specification is applicable, but preferable means are means described below.

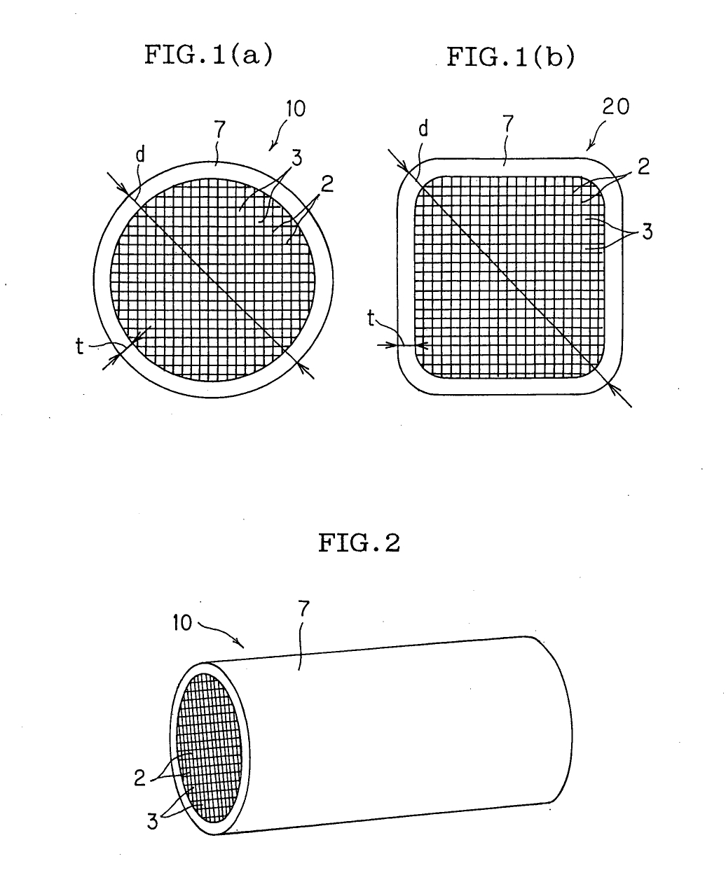

FIG. 2 is a perspective view showing one example of a ceramic honeycomb structure, and FIG. 1(a) is a front view showing an end face of the ceramic honeycomb structure. For example, a ceramic honeycomb structure 10 obtained by extruding a ceramic material such as alumina has a cylindrical shape as shown, and includes an outer peripheral wall 7, partition walls 2 disposed inside the outer peripheral wall 7, and a plurality of through-holes 3 partitioned by the partition walls 2 and formed in an axial direction of a cylindrical article. A thickness of the outer peripheral wall 7 is shown by t, and an outer diameter of the ceramic honeycomb structure 10 is shown by d. A sectional shape of the through-hole 3 is shown in a quadrangular shape, and additionally it is possible to form arbitrary shapes such as a triangular shape, a pentagonal shape, a hexagonal shape, a heptagonal shape, a circular shape, an elliptic shape, and an oblong shape.

The ceramic honeycomb structure 10 has a cylindrical shape, but another cylindrical article may be formed in the method of manufacturing the ceramic honeycomb structure according to the present invention. That is, the cylindrical article may be formed whose section shape vertical to the axial direction is elliptic, oblong, triangular, quadrangular, pentagonal, hexagonal, or heptagonal. FIG. 1(b) is a front view showing an end face of another example, and a shown ceramic honeycomb structure 20 has a substantially square pole shape. The outer diameter of a ceramic honeycomb structure which is not cylindrical, that is, a ceramic honeycomb structure whose sectional shape vertical to the axial direction is not circular is defined as the diameter of a circle circumscribed with a sectional contour (see outer diameter d shown in FIG. 1(b)).

In the ceramic honeycomb structure illustrated by the ceramic honeycomb structure 10 or 20, as described in the following examples, a ceramic honeycomb intermediate formed article is obtained whose outer peripheral wall has a thickness of 1/15 to 1/120 with respect to the outer diameter in view of the change of the outer diameter generated at the firing time. The outer peripheral wall of the ceramic honeycomb fired article obtained by firing the ceramic honeycomb intermediate formed article is machined to thereby prepare the structure. It is to be noted that the article is dried before fired if necessary.

### EXAMPLES

### Example 1

A raw material mainly composed of an alumina material was extruded, and a cylindrical ceramic honeycomb intermediate formed article was obtained. The ceramic honeycomb intermediate formed article was formed in such a manner as to obtain a partition wall thickness of 0.7 mm, a cell pitch of 3.4 mm, an outer peripheral wall thickness of 2.5 mm, an outer diameter of 158 mm, and a total length of 1000 mm.

Next, after drying this ceramic honeycomb intermediate formed article, the article was fired at 1500° C., and a ceramic honeycomb fired article having an outer diameter of 152 mm, and an outer peripheral wall thickness of 2.4 mm was obtained. Moreover, side surfaces at both ends of this ceramic honeycomb fired article were polished by a rotary grindstone polishing machine, and a ceramic honeycomb structure was obtained.

The obtained ceramic honeycomb structure had an outer peripheral wall thickness of 1.4 mm, and an outer diameter of 150 mm, and a deviation of a contour of a plane vertical to an axial line was 0.25 mm. When the outer surface of the ceramic honeycomb structure was visually observed, exposure of through-holes from the outer peripheral wall was not confirmed, and any micro concave/convex portion was not seen. Furthermore, when the inside of the through-hole was visually confirmed from the end face, any partition wall did not collapse even in the vicinity of the outer peripheral wall. It is to be noted that porosity (actual value measured in Archimedes method) of the ceramic honeycomb structure was 30%.

### Example 2

A raw material mainly composed of a cordierite material was extruded, and a cylindrical ceramic honeycomb intermediate formed article was obtained. The ceramic honeycomb intermediate formed article was formed in such a manner as to obtain a partition wall thickness of 0.3 mm, a cell pitch of 1.5 mm, an outer peripheral wall thickness of 2 mm, an outer diameter of 108 mm, and a total length of 300 mm.

Next, after drying this ceramic honeycomb intermediate formed article, the article was fired at 1400° C., and a ceramic honeycomb fired article having an outer diameter of 102 mm, and an outer peripheral wall thickness of 1.9 mm was obtained. Moreover, side surfaces at both ends of this ceramic honeycomb fired article were polished by a rotary grindstone polishing machine, and a ceramic honeycomb structure was obtained.

The obtained ceramic honeycomb structure had an outer peripheral wall thickness of 1 mm, and an outer diameter of 100 mm, and a deviation of a contour of a plane vertical to an axial line was 0.2 mm. When the outer surface of the ceramic honeycomb structure was visually observed, exposure of through-holes from the outer peripheral wall was not confirmed, and any micro concave/convex portion was not seen. Furthermore, when the inside of the through-hole was visually confirmed from the end face, any partition wall did not collapse even in the vicinity of the outer peripheral wall. It is to be noted that porosity (actual value measured in Archimedes method) of the ceramic honeycomb structure was 50%.

A method of manufacturing a ceramic honeycomb structure according to the present invention is preferable as means for manufacturing a filter for gas-liquid separation, solid-liquid separation, or gas-solid separation, or a ceramic honeycomb structure for use as a catalyst carrier. The filter is preferably used in removing suspension materials, bacterial, powder dust and the like in liquid or gas in fields such as water treatment, exhaust gas treatment (including automobile exhaust gas), medical field and food field. The catalyst carrier is preferably used in an exhaust gas purifying device for an automobile internal combustion engine, a deodorizing device and the like.

1. A method of manufacturing a ceramic honeycomb structure comprising a cylindrical article, and having: an outer peripheral wall; a partition wall disposed inside the outer peripheral wall; and a plurality of through-holes partitioned by the partition walls and formed in an axial direction of the cylindrical article, the method comprising:
an extruding step; a firing step; and a machining step,
the extruding step comprising the steps of: obtaining a ceramic honeycomb intermediate formed article having a thickness of the outer peripheral wall estimating a change of an outer diameter in the firing step,
the firing step comprising the steps of: firing the ceramic honeycomb intermediate formed article to obtain a ceramic honeycomb fired article, the machining step comprising the steps of:
machining the outer peripheral wall of the ceramic honeycomb fired article, and securing a dimensional precision of a predetermined outer diameter of the ceramic honeycomb fired article.

2. A method of manufacturing a ceramic honeycomb structure comprising a cylindrical article, and having: an outer peripheral wall; a partition wall disposed inside the outer peripheral wall; and a plurality of through-holes partitioned by the partition walls and formed in an axial direction of the cylindrical article, the method comprising:
an extruding step of extruding a raw material including a ceramic material, and obtaining a ceramic honeycomb intermediate formed article which has substantially the same shape as that of the ceramic honeycomb structure to obtain and whose outer peripheral wall has a thickness of 1/15 to 1/120 with respect to an outer diameter of the ceramic honeycomb intermediate formed article;
a firing step of firing the obtained ceramic honeycomb intermediate formed article to obtain a ceramic honeycomb fired article; and
a machining step of machining the outer peripheral wall of the obtained ceramic honeycomb fired article, and securing a dimensional precision of a predetermined outer diameter of the ceramic honeycomb fired article.

3. The method of manufacturing the ceramic honeycomb structure according to claim 2, wherein the thickness of the outer peripheral wall of the ceramic honeycomb intermediate formed article is 2 to 20 times that of the partition wall.

4. The method of manufacturing the ceramic honeycomb structure according to claim 1, wherein the dimensional precision of the predetermined outer diameter is 1 mm or less as a deviation of a contour of a plane vertical to an axial line of the ceramic honeycomb structure.

5. The method of manufacturing the ceramic honeycomb structure according to claim 2, wherein the dimensional precision of the predetermined outer diameter is 1 mm or less as a deviation of a contour of a plane vertical to an axial line of the ceramic honeycomb structure.

6. The method of manufacturing the ceramic honeycomb structure according to claim 1, wherein the ceramic honeycomb structure is porous, and has a porosity of 20 to 60%.

7. The method of manufacturing the ceramic honeycomb structure according to claim 2, wherein the ceramic honeycomb structure is porous, and has a porosity of 20 to 60%.

8. The method of manufacturing the ceramic honeycomb structure according to claim 1, wherein the ceramic honeycomb structure has an outer diameter of 50 mm or more.

9. The method of manufacturing the ceramic honeycomb structure according to claim 2, wherein the ceramic honeycomb structure has an outer diameter of 50 mm or more.

10. The method of manufacturing the ceramic honeycomb structure according to claim 1, wherein a sectional shape of the ceramic honeycomb structure vertical to an axial direction of the cylindrical article is at least one selected from a group consisting of a circular shape, an elliptical shape, an oblong shape, a triangular shape, a quadrangular shape, a pentagonal shape, a hexagonal shape, and a heptagonal shape.

11. The method of manufacturing the ceramic honeycomb structure according to claim 2, wherein a sectional shape of the ceramic honeycomb structure vertical to an axial direction of the cylindrical article is at least one selected from a group consisting of a circular shape, an elliptical shape, an oblong shape, a triangular shape, a quadrangular shape, a pentagonal shape, a hexagonal shape, and a heptagonal shape.

12. The method of manufacturing the ceramic honeycomb structure according to claim 1, wherein a shape of the through-hole in a plane vertical to an axial direction of the cylindrical article of the ceramic honeycomb structure is at least one selected from a group consisting of a triangular shape, a quadrangular shape, a pentagonal shape, a hexagonal shape, a heptagonal shape, a circular shape, an elliptical shape, and an oblong shape.

13. The method of manufacturing the ceramic honeycomb structure according to claim 2, wherein a shape of the through-hole in a plane vertical to an axial direction of the cylindrical article of the ceramic honeycomb structure is at least one selected from a group consisting of a triangular shape, a quadrangular shape, a pentagonal shape, a hexagonal shape, a heptagonal shape, a circular shape, an elliptical shape, and an oblong shape.

14. A ceramic honeycomb intermediate formed article constituting a ceramic honeycomb structure which is fired later and whose outer peripheral wall is machined, the article comprising a cylindrical article, and having:
an outer peripheral wall; a partition wall disposed inside the outer peripheral wall; and a plurality of through-holes partitioned by the partition walls and formed in an axial direction of the cylindrical article, the outer peripheral wall having a thickness of 1/15 to 1/120 with respect to an outer diameter of the article.

15. The ceramic honeycomb intermediate formed article according to claim 14, wherein the outer peripheral wall has a thickness of 2 to 20 times that of the partition wall.
